(19) United States
(12) Patent Application Publication
(10) Pub. No.: US 2026/0164008 A1
(43) Pub. Date: Jun. 11, 2026

(54) CALIBRATION OF EXTENDED REALITY NEAR-EYE DISPLAY DEVICES BASED ON PRESCRIPTION LENS PARAMETERS

(71) Applicant: GOOGLE LLC, Mountain View, CA (US)

(72) Inventors: Jennifer Han, Mountain View, CA (US); Brian Cousins, Waterloo (CA); Brian Watson Cranton, Kitchener (CA); David Hoffman, Los Gatos, CA (US)

(21) Appl. No.: 19/181,078

(22) Filed: Apr. 16, 2025

Related U.S. Application Data
(60) Provisional application No. 63/639,126, filed on Apr. 26, 2024.

(51) Int. Cl. H04N 13/327; H04N 13/344; H04N 13/383; H04N 13/398

(52) U.S. Cl. CPC H04N 13/327; H04N 13/344; H04N 13/383; H04N 13/398; H04N 2213/001; H04N 2213/008

(57) ABSTRACT

Prescription profile information for corrective lenses used in conjunction with a near-eye display device is obtained by the near-eye display device to facilitate correction of aberrations introduced by the corrective lenses. The prescription profile information can be transmitted electronically to the near-eye display device, embedded on the lens surface of the corrective lens itself using a near invisible marking such as near-infrared ink that can be detected by a gaze-tracking camera of the near-eye display device, or the near-eye display device can infer the prescription profile information for the corrective lenses based on the locations of glints reflected by the corrective lenses and detected by the gaze-tracking camera. Based on the prescription profile information, the near-eye display device calibrates the display, sensors, and/or gaze-tracking circuitry to correct aberrations introduced by the corrective lenses.

### BACKGROUND

In some near-eye display devices, images are displayed to a user by coupling light beams from a projector into an incoupler of a lightguide. The incoupler then provides the light beams to a main body of the lightguide within which the light beams propagate by total internal reflection. The light beams propagate through the lightguide until they are received at an outcoupler of the lightguide configured to direct the light beams out of the lightguide and toward the user such that images are presented to the user in a field of view area of the eyewear display device. Still other systems may make use of one or more semi-reflective mirrors to combine an image from a projector with a view of the world. Occluding display systems make use of a display and an optical magnifier to permit near-eye viewing. Near-eye display devices (especially those incorporating eye-tracking technology) are typically calibrated for users who do not require vision correction, using what is referred to as plano calibrations, as such calibrations lack optical power for vision correction (e.g., nearsightedness, farsightedness, or astigmatism). Users who require vision correction may wear eyeglasses under the device, use custom prescription inserts, use integrated prescription lenses, or apply prescription adjustments to the eyewear display device. However, modifying the near-eye display device to allow prescription correction can degrade the performance of the near-eye display device.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of an example near-eye display device housing a projector system configured to project images toward the eye of a user through corrective lenses in accordance with some embodiments.

FIG. 2 is a diagram of a projection system that projects images directly onto the eye of a user via display light, in accordance with some embodiments.

FIG. 3 is a diagram of a near-eye display device that receives a transmission of user prescription profile information to calibrate projector and gaze-tracking circuitry in accordance with some embodiments.

FIG. 4 is a diagram illustrating gaze-tracking at a near-eye display device in accordance with some embodiments.

FIG. 5 is a diagram illustrating deriving user prescription profile information of a corrective lens insert at a near-eye display device in accordance with some embodiments.

FIG. 6 is a diagram of a corrective lens having a marking indicating prescription profile information in accordance with some embodiments.

FIG. 7 is a diagram illustrating deriving user prescription profile information based on a marking detected by an eye-tracking camera at a near-eye display system in accordance with some embodiments.

FIG. 8 is a diagram illustrating an emitter projecting an elongated light beam illuminating a marking indicating prescription profile information for a corrective lens used in conjunction with a near-eye display device in accordance with some embodiments.

### DETAILED DESCRIPTION

Near-eye display devices may include an optical combiner that is substantially transparent and includes a lens element and a lightguide, such that light from real-world scenes corresponding to the environment around the near-eye display device passes through the optical combiner to the eye of a user while images or other graphical content output from a projector are combined with real-world images of the user's environment to provide an augmented reality (AR) or extended reality (XR) experience to the user. Alternative implementations include a display viewed through a magnifying lens that occludes world light, as is often found in virtual reality (VR) and some XR systems. Such near-eye display systems sometimes require ophthalmic corrective lenses to accommodate those users who require vision correction. In some cases, including a corrective optical prescription in a near-eye display device requires configuring the optical combiner to accommodate both a lightguide and a separate corrective lens, either as part of eyeglasses worn by the user or as a lens that is inserted into, or attached to, the optical combiner.

Incorporating a corrective optical prescription in a near-eye display device degrades the system performance due to the complex interaction between vision correction optical power and the other optical components in the system. The parameters of a prescription correction can include optical power, sizing, and lens parameters. Optical power parameters include defocus (sphere or SPH), astigmatism (cylinder (CYL) and axis), prism, and reading addition (ADD). Sizing consists of user measurements such as pupillary distance, optical center height, as-worn pantoscopic tilt, and as-worn vertex distance. Lens parameters include optical material, coatings, tints, and polarization. Each of these parameters combine in corrective lenses to modify the world to match the user's aberrated eyes so that they can see clearly. Incorporating these lenses can change the optical paths within a near-eye display system and impact the image distortion, size and chromatic properties. Additionally, other systems beyond the display, such as eye-tracking components, may be closely calibrated to have a direct view of the eye without any additional optical layers. The experience of a user using such a system can be impacted by a more degraded display experience and/or a degraded user interface experience if it makes use of eye tracking.

Degradation of near-eye system performance may also relate to sizing and the interaction between the eyewear display device and spatial elements such as the as-worn optical center or prism reference point of the vision correction. This spatial parameter can introduce an angular shift in perceived image location in an effect that is referred to as induced prism. Further, optical power and sizing parameters interact with each other such that, e.g., the as-worn corrective power is a function of sizing parameters such as as-worn vertex distance so that changing the as-worn vertex distance through adjustments can impact the vision correction optical power.

Other lens parameters, such as color tint, can impact how a display from an eyewear display device is perceived. Color tints may even mask or filter out critical display symbology, text, or imagery in some circumstances. Additional prescription lens parameters such as anti-fatigue functionality, progressive correction, or myopia treatment features may also impact XR system performance, such as that of displays, world viewing cameras, eye tracking, and other features of an eyewear display device.

Other functionality of the device may make use of the eye gaze position in order to optimize image quality. One such technique, known as foveated rendering, renders the image in highest quality where the person is fixating (looking at) and at a degraded (more efficient) quality in areas of the periphery. This technique requires a system that can track where the eyes are fixating in real time. Another system functionality is to utilize the detected fixation point within an image as a mechanism for the user to interact with the software. This can include selection actions that might otherwise be selected with the hands (e.g. via a game controller, mouse, keyboard, etc.).

Effective gaze tracking and pupil tracking benefits from a carefully calibrated optical system that includes eye tracking sensors and display optical components. The insertion of additional lens elements can distort the display system and alter the optical path for eye tracking systems. To mitigate this, a near-eye display device can digitally compensate ophthalmic elements for vision correction-induced device performance degradation. However, in order to do so, the near-eye display device should have access to information regarding the particular characteristics of the vision correction that was applied. For example, the vision correction prescription lenses used in conjunction with a near-eye display device may cause the display to be in an inappropriate location, but the near-eye display device cannot apply pixel shifting to the display to compensate for the vision correction without knowledge of the prescription lens parameters. As another example, some near-eye display devices are equipped with world-facing sensors such as cameras to facilitate mixed reality interactions with the world. Vision correction could disrupt alignment between the world-facing camera and projected display imagery, which could negatively impact the user's experience. Some near-eye devices include gaze tracking capabilities (also referred to as eye-tracking) which could be negatively impacted by vision correction lenses but which can also be tuned to compensate for any aberrations if the prescription lens parameters are known.

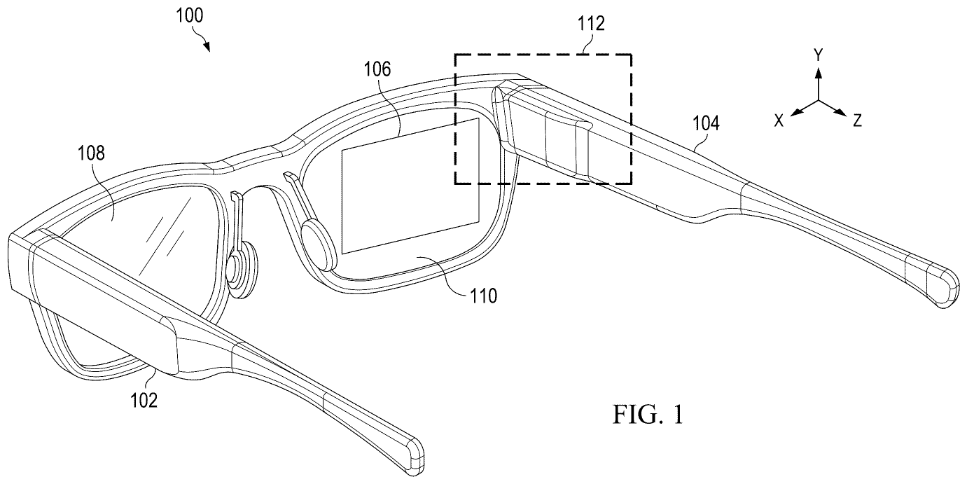

FIGS. 1-8 illustrate techniques for providing prescription profile information for corrective lenses used in conjunction with a near-eye display device to the near-eye display device to facilitate correction of aberrations introduced by such corrective lenses. In some embodiments, the prescription profile information is provided when a technician, optician, user, or other person or mechanism installs prescription corrective lenses in the near-eye display device. In other embodiments, the prescription profile information is embedded in or attached to the corrective lens itself, whether electronically using an RFID chip or similar, on the lens surface using a near invisible marking such as near-infrared ink that can be detected by a gaze-tracking camera of the near-eye display device or by a smartphone or other handheld electronic device but not a human eye, or a laser engraving similar to those used on some digital freeform ophthalmic lenses. The information format of the prescription profile information is a coded character string, a bar code, or a storage device such as a USB stick in some embodiments. In some embodiments, the near-eye display device includes an elongated infrared emitter that emits infrared light onto a marking such as a bar code on the corrective lens indicating the prescription profile information. In some embodiments, the near-eye display device infers the prescription profile information for the corrective lenses based on the locations of glints reflected by the corrective lenses and detected by the gaze-tracking camera.

In the case of adjustable or settable vision correction, such as a microscope or binoculars with an adjustable diopter eyepiece whose SPR power changes with rotation of the eyepiece or a knob, the prescription profile information is directly inferred from a measurement device such as an encoder. For example, if a microscope or binoculars used in conjunction with an eyewear display device has a ±4 diopter eyepiece whose power is set by rotating the eyepiece, the encoder determines power based on that rotation in some embodiments.

Based on the prescription profile information, the near-eye display device makes appropriate adjustments to compensate for or correct the aberrations introduced by the corrective lens(es). In some embodiments, a controller of a projector (e.g., a microdisplay) adjusts display settings of the projector based on the prescription profile information. For example, in some embodiments, the display optics of the near-eye display device “pixel shift” or otherwise change the apparent spatial location of projected pixels to appear at their intended locations during use. Such a shift compensates for any shifts introduced by the corrective lenses. In some embodiments, the world-facing sensors of the near-eye display device operate through at least one of a coordinate transformation, a generalized linear transform, and a non-linear transform which adjusts the world-facing sensors to compensate for effects from the corrective lenses that impact the alignment between the world-facing sensors and the user's eye gaze position and display perception. Further, a gaze-tracking offset is applied in some embodiments to compensate for some or all of the impacts from corrective lenses on the gaze-tracking system of the near-eye display device. Such an offset replaces, simplifies, or augments any in-situ gaze-tracking calibrations that are otherwise performed at the near-eye display device.

FIG. 1 illustrates an example near-eye display device in the form of an eyewear display device 100 in accordance with some embodiments. The eyewear display device 100 has a support structure 102 that includes an arm 104, which houses a projection system configured to project images toward the eye of a user, such that the user perceives the projected images as being displayed in a field of view (FOV) area 106 of a display at one or both of lens elements 108, 110. In the depicted embodiment, the eyewear display device 100 is a head-mounted display that includes the support structure 102 configured to be worn on the head of a user and has a general shape and appearance of an eyeglasses frame or sunglasses frame. The support structure 102 contains or otherwise includes various components to facilitate the projection of such images toward the eye of the user, such as a projector (e.g., microdisplay) and an optical system such as a magnifying lens or a lightguide to guide display light emitted by the projector toward an exit pupil for viewing by a user. In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth interface, a Wi-Fi interface, and the like. Further, in some embodiments, the support structure 102 further includes one or more batteries or other portable power sources for supplying power to the electrical components of the eyewear display device 100. In some embodiments, some or all of these components of the eyewear display device 100 are fully or partially contained within an inner volume of support structure 102, such as within the arm 104 in region 112 of the support structure 102. It should be noted that while an example form factor is depicted, it will be appreciated that in other embodiments the eyewear display device 100 may have a different shape and appearance from the eyeglasses frame depicted in FIG. 1.

One or both of the lens elements 108, 110 are used by the eyewear display device 100 to provide a display in which rendered graphical content can be superimposed over or otherwise provided in conjunction with a real-world view as perceived by the user through the lens elements 108, 110. For example, display light used to form a perceptible image or series of images may be projected (e.g., emitted) by a projector of the eyewear display device 100 onto the eye of the user via a series of optical elements, such as a lightguide formed at least partially in the corresponding lens element. One or both of the lens elements 108, 110 thus include at least a portion of a lightguide that routes display light received by an incoupler of the lightguide to an outcoupler of the lightguide, which outputs the display light toward an eye of a user of the eyewear display device 100. The display light is modulated onto the eye of the user such that the user perceives the display light as an image. In addition, each of the lens elements 108, 110 is sufficiently transparent to allow a user to see through the lens elements to provide an FOV area 106 of the user's real-world environment such that the image appears superimposed over at least a portion of the real-world environment.

In some embodiments, the projector is a digital light processing-based projector, a micro-projector, a scanning laser projector, or any combination of a modulative light source such as a laser or one or more LEDs and a dynamic reflector mechanism such as one or more dynamic scanners or digital light processors. In some embodiments, the projector includes multiple laser diodes (e.g., a red laser diode, a green laser diode, and/or a blue laser diode). The projector is communicatively coupled to the controller and a non-transitory processor-readable storage medium or a memory that stores processor-executable instructions and other data that, when executed by the controller, cause the controller to control the operation of the projector.

In some embodiments, corrective lenses (not shown) are used in conjunction with the eyewear display device 100. For example, in some cases a user wears eyeglasses with corrective lenses under the eyewear display device 100. In other embodiments, custom prescription corrective lens inserts are held by the support structure 102 on an eye-side of the lens elements 108, 110. In yet other embodiments, prescription corrective lenses are integrated with the lens elements 108, 110

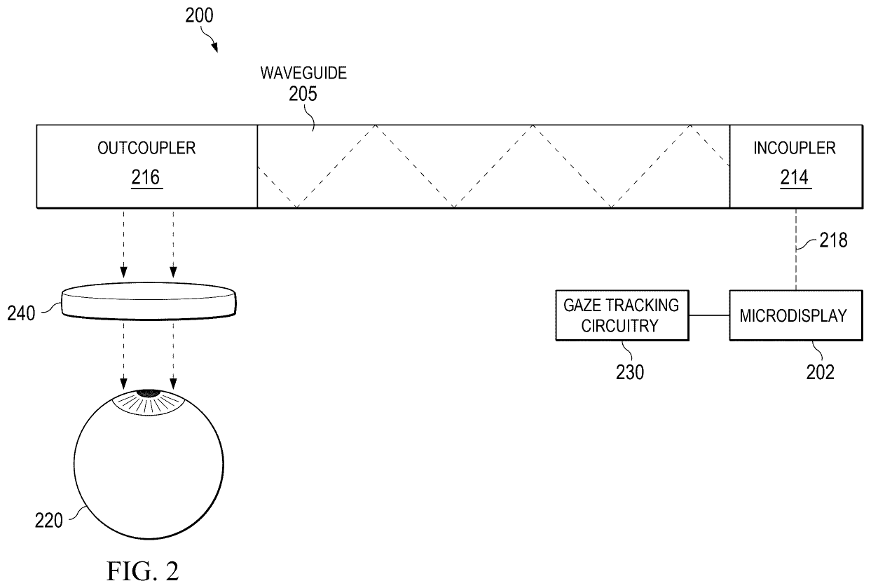

FIG. 2 illustrates a simplified block diagram of a projection system 200 that projects images through a corrective lens 240 directly onto the eye of a user via display light. The projection system 200 includes a microdisplay 202 and a lightguide 205. The term “lightguide,” as used herein, will be understood to mean a combiner using one or more of total internal reflection (TIR), partial internal reflection (PIR), specialized filters, and/or reflective surfaces, to transfer light from an incoupler (such as the incoupler 214) to an outcoupler (such as the outcoupler 216). In some display applications, the light is a collimated image, and the lightguide transfers and replicates the collimated image to the eye. In some embodiments, the projection system 200 is implemented in an eyewear display device or other display system, such as the eyewear display device 100 of FIG. 1.

The microdisplay 202 is an optical engine that includes one or more display light sources configured to generate and output display light 218 (e.g., visible display light such as red, blue, and green display light and/or non-visible display light such as infrared display light) representing an image. In some embodiments, the microdisplay 202 is coupled to a driver or other controller (not shown), which controls the timing of emission of display light from the display light sources of the microdisplay 202 in accordance with instructions received by the controller or driver from a computer processor coupled thereto to modulate the display light 218 to be perceived as images when output to the retina of an eye 220 of a user. For example, during the operation of the projection system 200, multiple display light beams having respectively different wavelengths are output by the display light sources of the microdisplay 202, then combined via a beam combiner (not shown), before being directed to the eye 220 of the user. The microdisplay 202 modulates the respective intensities of the display light beams so that the combined display light reflects a series of pixels of an image, with the particular intensity of each display light beam at any given point in time contributing to the amount of corresponding color content and brightness in the pixel being represented by the combined display light at that time.

Further, the lightguide 205 includes an incoupler 214 and an outcoupler 216, with the outcoupler 216 being optically aligned with an eye 220 of a user in the present example. In some embodiments, the incoupler 214 has a substantially rectangular, circular, or elliptical profile and is configured to receive the display light 218 and direct the display light 218 into the lightguide 205. To this end, the incoupler 214 includes one or more reflective facets configured to reflect and direct display light 218 into the lightguide 205. Such reflective facets, for example, include one or more structures disposed within the lightguide 205 that each has one or more reflective surfaces, reflective coatings, mirrors (e.g., di-electric mirrors, metallic mirrors, Bragg facets), mirror coatings, or any combination thereof. According to embodiments, in response to receiving display light 218, the incoupler 214 is configured to provide the display light 218 to lightguide 205 such that the display light 218 propagates through lightguide 205 via TIR until it is received by the outcoupler 216. As an example, the incoupler 214 provides display light 218 to lightguide 205 such that display light 218 performs one or more bounces (e.g., reflects off a surface of lightguide 205) before being received by the outcoupler 216. After receiving display light 218, the outcoupler 216 is configured to direct display light 218 out of the lightguide 205 and toward the eye 220 of the user. For example, the outcoupler 216 includes one or more reflective facets configured to reflect and direct display light 218 out of the lightguide 205 and toward the eye 220 of a user such that one or more images are displayed in the FOV area 106. Such reflective facets, for example, include one or more structures disposed within the lightguide 205 that each has one or more reflective surfaces, reflective coatings, mirrors (e.g., di-electric mirrors, metallic mirrors, Bragg facets), mirror coatings, or any combination thereof. In an embodiment, the display light 218 directed out of the lightguide 205 by the outcoupler 216 forms an exit pupil facing the corrective lens 240 at a position near the eye 220 of the user. An exit pupil, for example, includes the image of the display light 218 emitted by the microdisplay 202 and refers to the location along the optical path where two or more beams of the display light 218 intersect. As an example, the width (e.g., smallest dimension) of a given exit pupil approximately corresponds to the diameter of the display light 218 corresponding to that exit pupil. Accordingly, the exit pupil can be considered a “virtual aperture”.

Although not shown in the example of FIG. 2, in some embodiments additional optical components are included in any of the optical paths between the microdisplay 202 and the incoupler 214, between the incoupler 214 and the outcoupler 216, and/or between the outcoupler 216 and the eye 220 (e.g., in order to shape the display light for viewing by the eye 220 of the user). In some embodiments, an electrochromic reflector is used to steer light into the incoupler 214 so that light is coupled into incoupler 214 at the appropriate angle to encourage the propagation of the light in lightguide 205 by TIR. Also, in some embodiments, an exit pupil expander (EPE), such as a fold grating, is arranged in an intermediate stage between incoupler 214 and outcoupler 216 to receive light that is coupled into lightguide 205 by the incoupler 214, expand the light, and redirect the light towards the outcoupler 216, where the outcoupler 216 then couples the display light out of lightguide 205 (e.g., toward the eye 220 of the user).

According to some embodiments, projection system 200 further includes gaze-tracking circuitry 230. Gaze-tracking circuitry 230, for example, includes circuitry, sensors (e.g., infrared sensors, laser sensors), cameras, or any combination thereof configured to determine the direction of the gaze of an eye 220 of the user. Based on a determined direction of the gaze of an eye 220 of the user, gaze-tracking circuitry 230 is configured to determine which portion of the FOV area 106 an eye 220 of the user is looking at. As an example, based on a determined first direction of the gaze of an eye 220 of the user, gaze-tracking circuitry 230 is configured to determine that the eye 220 of the user is looking at a first portion of the FOV area 106. As another example, based on a determined second direction of the gaze of an eye 220 of the user, gaze-tracking circuitry 230 is configured to determine that the eye 220 of the user is looking at a second portion of the FOV area 106 that is different from the first portion of the FOV area 106. However, as explained above, if corrective lenses, such as corrective lens 240, are used in conjunction with the eyewear display device 100, different types of aberrations may occur in different areas of the corrective lenses (e.g., centrally versus peripherally). Accordingly, an offset may need to be applied to the gaze-tracking circuitry 230 based on the prescription profile information and the gaze direction. In some embodiments, the projection system 200 includes a controller (not shown) that applies an offset to the gaze-tracking circuitry 230 based on the prescription profile information to compensate for refraction of display light by the corrective lens 240.

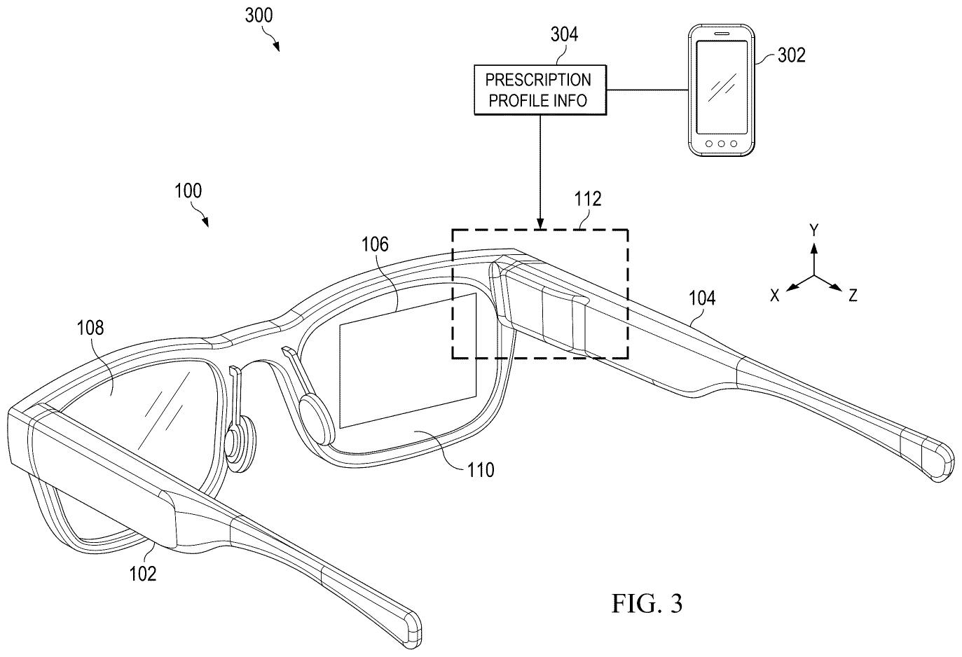

FIG. 3 is a diagram of an eyewear display device 300 that receives a transmission of user prescription profile information 304 to calibrate the microdisplay 202 and gaze-tracking circuitry 230 in accordance with some embodiments. In the illustrated example, the prescription profile information 304 is communicated to the XR device wirelessly or via wired connection from a user electronic device 302. The user electronic device 302 transmits the prescription profile information 304 electronically to the eyewear display device 300 when the user logs into the eyewear display device 300 from the user electronic device 302 or a remote server in some embodiments.

In some embodiments, the prescription profile information 304 includes one or more of elements of the user's corrective lens prescription (e.g., SPH, CYL, AXIS, prism, ADD), the user's sizing measurements (IPD, OC frame height), and correction lens parameters (lens material, lens type such as single vision or anti-fatigue, color or sunglass tints). The prescription profile information 304 is either encrypted personal health information (PHI) or corrective action system information derived from the prescription data that masks the user's PHI in some embodiments. Encrypting or masking PHI protects the security of that sensitive personal medical information.

In some embodiments, the eyewear display device 300 parses the prescription profile information 304 into actionable parameters (pixel shift, display color shifts) any time between obtaining the prescription profile information 304 and the installation of the corrective lenses. In other embodiments, the eyewear display device 300 parses the prescription profile information 304 into actionable parameters after the corrective lenses are installed, e.g., upon installation of a different corrective lens for implementations with removeable corrective lenses.

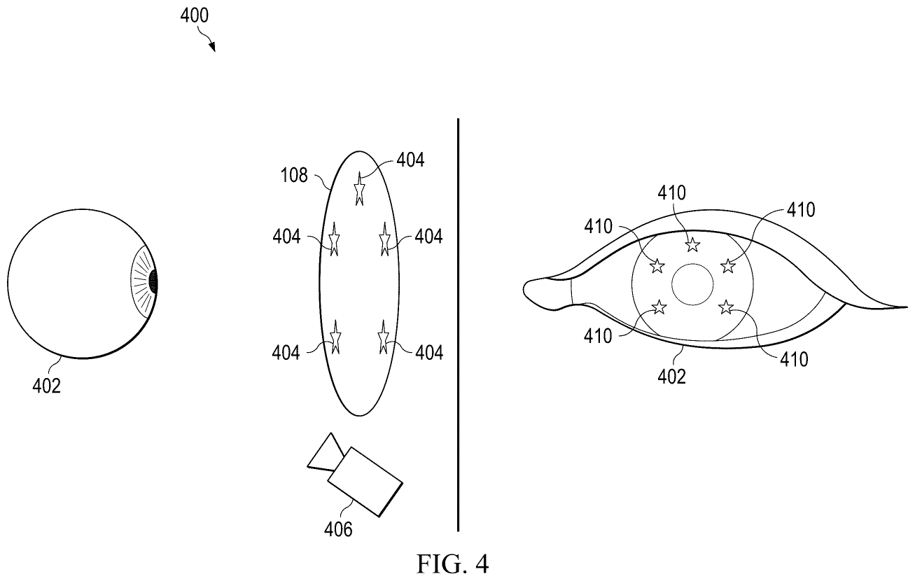

FIG. 4 is a diagram illustrating gaze tracking at a gaze-tracking system 400 of an eyewear display device such as eyewear display device 100 in accordance with some embodiments. The gaze-tracking system 400 includes a set of infrared or near-infrared emitters 404 positioned about the lens element 108, 110 and an eye-tracking camera 406 directed towards an eye 402 of a user, as illustrated in the left side of FIG. 4. In some embodiments, the eye-tracking camera 406 is incorporated as a component of the gaze-tracking circuitry 230. In some embodiments, the eye-tracking camera 406 is positioned to view the eye 402 from a location adjacent to the system optics of the eyewear display device 100, or behind the system optics. The right side of FIG. 4 illustrates the view of the eye-tracking camera 406, which sees reflections 410 of the emitters 404 patterned on the cornea of the eye 402. The gaze-tracking circuitry 230 determines the gaze direction of the user's eye 402 based on the positions of the reflections 410.

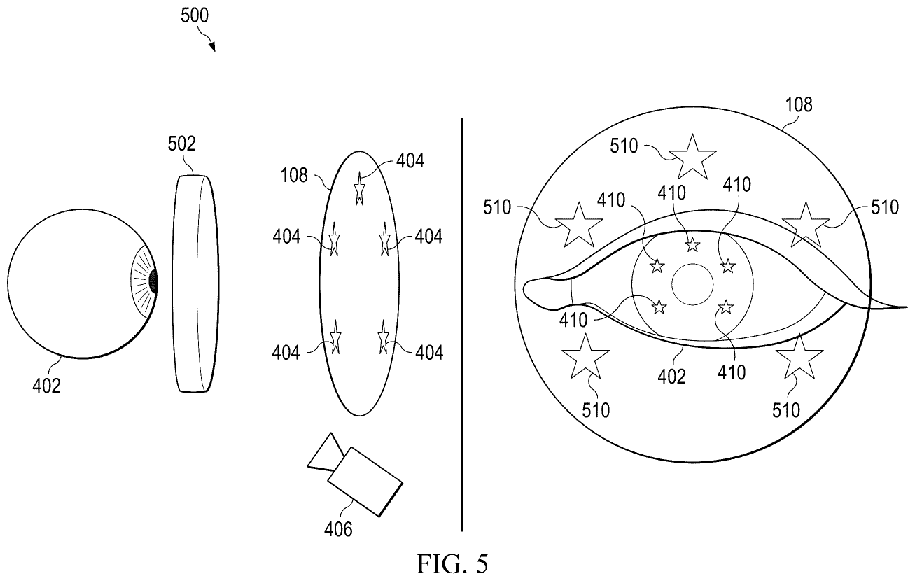

FIG. 5 is a diagram illustrating a gaze-tracking system 500 that derives user prescription profile information of a corrective lens insert 502 at an eyewear display device such as eyewear display device 100 in accordance with some embodiments. When the corrective lens insert 502 is installed in or used in conjunction with the eyewear display device 100, the reflections 410 patterned on the cornea of the eye 402 remain mostly unchanged but additional specular reflections 510 from the front surface of the corrective lens insert 502 may also be visible. Based on the positions of the additional specular reflections 510, the gaze-tracking circuitry 230 infers the prescription profile information 304 for the corrective lens insert 502.

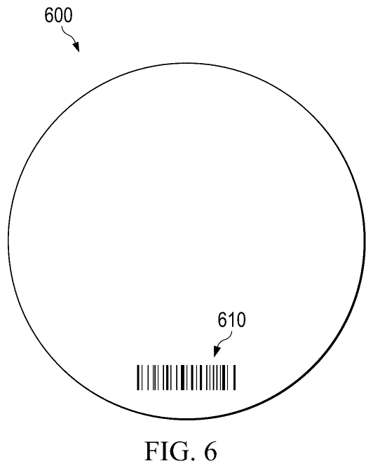

In some embodiments, rather than the gaze-tracking circuitry 230 inferring the prescription profile information 304 for the corrective lens insert 502 from specular reflections 510, the prescription profile information 304 is encoded on the corrective lens insert itself. FIG. 6 is a diagram of a corrective lens 600 having a marking illustrated in the form of a barcode 610 indicating prescription profile information 304 that is reflective in infrared or near-infrared light in accordance with some embodiments. The magnitude of reflections from the lens surface is related to anti-reflective coatings on the corrective lens 600. In order to convey information about the corrective lens 600 to the system, the corrective lens 600 uses structured lens reflections to communicate lens properties to the eye-tracking camera.

In the illustrated example corrective lens 600, a barcode 610 is added to the bottom edge of the corrective lens 600. Although the barcode 610 is illustrated in black, in an actual corrective lens 600 the barcode 610 is patterned to only be visible in infrared. The barcode 610 is positioned such that it is visible by the eye-tracking camera. The barcode 610 or other marking is patterned onto the corrective lens 600 via layering on additional hot mirror coatings, or by removal of anti-reflective coatings (e.g., films) that are patterned with the stripes of a barcode in some embodiments. In some embodiments, the corrective lens 600 is treated with an anti-reflective coating in order to minimize reflections in visible and infrared wavelengths.

Various approaches may be employed to achieve modulation in the barcode 610 in response to infrared illumination. In some embodiments, hot mirror coatings are deposited on the corrective lens 600 in the pattern of the barcode 610. This may involve fabricating a mask layer that adheres to the corrective lens 600 and then applying a series of thin film layers that preserve visible light transmissions but reflect at the target infrared wavelength. This technique increases the reflectivity in portions of the corrective lens 600 having the thin film layers by a factor of more than 30. Other embodiments involve removing the anti-reflective films in the pattern of the barcode 610. In some cases, this involves fabricating a mask of the barcode 610 that adheres to the corrective lens 600 and then applying high intensity ultraviolet light or a chemical treatment in order to remove the anti-reflective films from that part of the corrective lens 600. Removing the anti-reflective films from the corrective lens 600 increases the infrared reflectivity in the treated zones by a factor of 3 to 10.

Nominally, both approaches increase the reflectance of the light in those positions and thus the contrast of the barcode 610 may be inverted for a clearer signal. Information encoded in the barcode 610 is a serial number which would be used as part of a database to describe the corrective lens properties in some embodiments. In other embodiments, the information encoded in the barcode 610 alternatively or additionally includes prescription profile information 304 such as a lens sphere power, CYL power, and the CYL axis of the corrective lens 600. In some embodiments, the barcode 610 encodes the pupil height and lens base curve of the corrective lens 600.

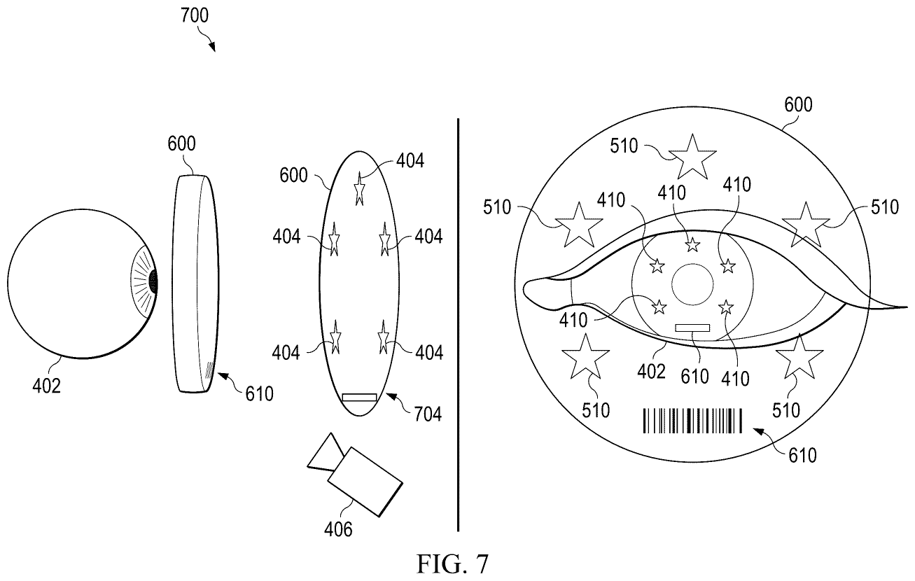

FIG. 7 is a diagram illustrating a gaze-tracking system 700 deriving prescription profile information based on a marking in the form of a barcode 610 detected by an eye-tracking camera 406 at an eyewear display device such as eyewear display device 100 in accordance with some embodiments. To enable the eye-tracking camera 406 to read the full barcode 610, the gaze-tracking system 700 includes an emitter 704 to project an elongated infrared light beam through the corrective lens 600 toward the eye 402 of the user. The emitter 704 is a glint source which projects light that is reflected from the barcode 610 to the eye-tracking camera 406 in a continuous fashion over the length of the barcode 610. In some embodiments, the emitter 704 itself is elongated and is a light-pipe or a frustrated fiberoptic attached to an emitter. The emitter 704 is positioned such that it is oriented with the barcode 610 to create a line of illumination crossing the barcode 610. In some embodiments, the emitter 704 is added to the emitters 404 adjacent to an optics assembly of the eyewear display device 100.

The reflective barcode 610 is patterned directly on the corrective lens 600 at the lower edge in some embodiments. When the eye-tracking camera 406 is positioned such that it would otherwise detect a first surface reflection from the elongated infrared emitter 704 off the corrective lens 600, the eye-tracking camera 406 records a nominal image of the shape of the continuous elongated infrared emitter 704. If there is a pattern on the lens that modulates that reflection strength, this modulation pattern will be imaged by the eye tracking camera. In some embodiments, the elongated infrared emitter 704 is electrically controlled with an individually addressable circuit for operation only when reading the barcode 610 on the corrective lens 600 and not during regular eye tracking operations when it could interfere with gaze tracking that typically relies on point sources of infrared light. For example, in some embodiments a controller (not shown) activates the elongated infrared emitter 704 in response to a reset of the eyewear display device 100 and deactivates the elongated infrared emitter 704 while the gaze-tracking circuitry 230 is tracking a gaze direction of the eye 402 of the user.

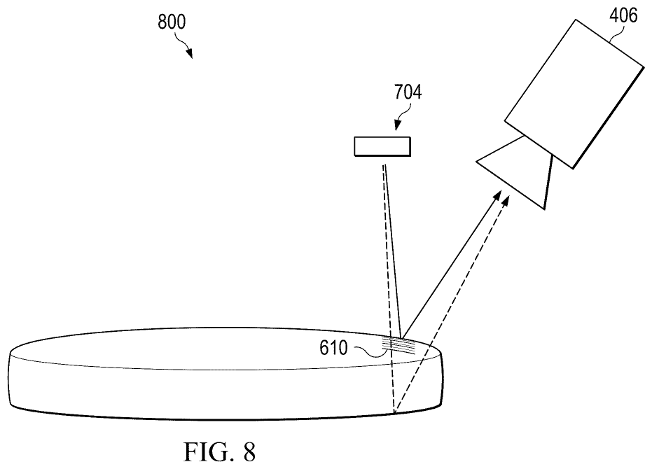

FIG. 8 is a diagram 800 illustrating the emitter 704 illuminating a marking in the form of the barcode 610 indicating prescription profile information for a corrective lens 600 used in conjunction with an eyewear display device such as eyewear display device 100 in accordance with some embodiments. As shown in the illustrated example, the corrective lens 600 has two reflections of the incoming light from the emitter 704. The surface of the corrective lens 600 not containing the barcode 610 degrades the contrast of the reflection of the barcode 610 and thus the modulation of the barcode 610 is high enough that there is a clear signal-to-noise ratio against secondary reflections in some embodiments. The eye-side surface of the corrective lens 600 is also treated with a continuous anti-reflective coating in order to minimize glare and stray light in visible and infrared spectra in some embodiments. The continuous anti-reflective coating also attenuates the flat reflection that reduces the contrast of the barcode 610. While the barcode 610 could be applied to the eye-side or the world-side of the corrective lens 600, in some embodiments the barcode 610 is applied to the world-side surface because the base curve on the world-side will be in a fairly narrow range and thus have minimal magnification/minification from the surface curvature. Further, the barcode structures which may contain delicate coatings will be on the device side and thus have greater protection from oils and abrasion of cleaning the eye-side surface.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A near-eye display device, comprising:
a frame to receive a corrective lens;
a projector to project display light;
an optical system to guide the display light to an exit pupil facing the corrective lens; and
a receiver to receive a transmission of prescription profile information for the corrective lens, wherein the near-eye display device is to adjust display settings of at least one of the projector and the optical system based on the prescription profile information.

2. The near-eye display device of claim 1, wherein the receiver is to receive the transmission in response to a user logging into the near-eye display device from an electronic device.

3. The near-eye display device of claim 1, further comprising:
a controller to adjust display settings of the projector based on the prescription profile information by shifting a location of pixels displayed at the near-eye display device to compensate for refraction of display light by the corrective lens.

4. The near-eye display device claim 1, further comprising:
gaze-tracking circuitry; and
a controller to apply an offset to the gaze-tracking circuitry based on the prescription profile information to compensate for refraction of display light by the corrective lens.

5. The near-eye display device of claim 1, further comprising:
a world-facing sensor; and
a controller to adjust the world-facing sensor based on the prescription profile information to compensate for an effect from the corrective lens on an alignment between the world-facing sensor and a user's eye gaze position.

6. A near-eye display device, comprising:
a frame to receive a corrective lens;
a projector to project display light;
an optical system to guide the display light to an exit pupil facing the corrective lens;
an emitter to project infrared light through the corrective lens toward an eye of a user;
gaze-tracking circuitry to detect glints reflected from the eye of the user; and
a processor to infer, based on locations of the glints, prescription profile information associated with the corrective lens, wherein the near-eye display device is to adjust display settings of at least one of the projector and the optical system based on the prescription profile information.

7. The near-eye display device of claim 6, further comprising:
a controller to adjust display settings of the projector based on the prescription profile information by shifting a location of pixels displayed at the near-eye display device to compensate for refraction of display light by the corrective lens.

8. The near-eye display device of claim 6, further comprising:
a controller to apply an offset to the gaze-tracking circuitry based on the prescription profile information to compensate for refraction of display light by the corrective lens.

9. The near-eye display device of claim 6, further comprising:
a world-facing sensor; and
a controller to adjust the world-facing sensor based on the prescription profile information to compensate for an effect from the corrective lens on an alignment between the world-facing sensor and a user's eye gaze position.

10. A near-eye display device, comprising:
a frame to receive a corrective lens;
a projector to project display light;
an optical system to guide the display light to an exit pupil facing the corrective lens;
an emitter to project an elongated infrared light beam through the corrective lens toward an eye of a user;
gaze-tracking circuitry to detect a marking indicating prescription profile information on the corrective lens illuminated by the elongated infrared light beam; and
a controller to adjust display settings of at least one of the projector and the optical system based on the prescription profile information.

11. The near-eye display device of claim 10, further comprising:
a controller to activate the emitter in response to a reset of the near-eye display device and to deactivate the emitter while the gaze-tracking circuitry is tracking a gaze direction of the eye of the user.

12. The near-eye display device of claim 10, further comprising:
a controller to adjust display settings of the projector based on the prescription profile information by shifting a location of pixels displayed at the near-eye display device to compensate for refraction of display light by the corrective lens.

13. The near-eye display device of claim 10, further comprising:
a controller to apply an offset to the gaze-tracking circuitry based on the prescription profile information to compensate for refraction of display light by the corrective lens.

14. The near-eye display device of claim 10, further comprising:
a world-facing sensor; and
a controller to adjust the world-facing sensor based on the prescription profile information to compensate for an effect from the corrective lens on an alignment between the world-facing sensor and a user's eye gaze position.

15. A method comprising:
accessing, at a near-eye display device, prescription profile information for a corrective lens used in conjunction with the near-eye display device, wherein accessing comprises at least one of:
receiving, at the near-eye display device, a transmission of the prescription profile information;
detecting, at gaze-tracking circuitry of the near-eye display device, glints from the corrective lens and inferring, based on locations of the glints, prescription profile information associated with the corrective lens; or
illuminating, with an elongated infrared light beam, the corrective lens and detecting, at the gaze-tracking circuitry of the near-eye display device, a marking indicating prescription profile information on the corrective lens illuminated by the elongated infrared light beam; and
adjusting display settings of the near-eye display device based on the prescription profile information.

16. The method of claim 15, wherein receiving the transmission is in response to a user logging into the near-eye display device from an electronic device.

17. The method of claim 15, wherein adjusting display settings comprises:
shifting a location of pixels displayed at the near-eye display device to compensate for refraction of display light by the corrective lens.

18. The method of claim 15, further comprising:
applying an offset to the gaze-tracking circuitry based on the prescription profile information to compensate for refraction of display light by the corrective lens.

19. The method of claim 15, further comprising:
adjusting a world-facing sensor of the near-eye display device based on the prescription profile information to compensate for an effect from the corrective lens on an alignment between the world-facing sensor and a user's eye gaze position.

20. The method of claim 15, further comprising:
activating emission of the elongated infrared light beam in response to a reset of the near-eye display device and deactivating emission of the elongated infrared light beam while the gaze-tracking circuitry is tracking a gaze direction of an eye of a user.
